(19) United States
(12) Patent Application Publication
(10) Pub. No.: US 2018/0148211 A1
(43) Pub. Date: May 31, 2018

(54) POTS WITH UNDERCUTS, OPENING MOLDS, FORMING MACHINES, AND PRODUCTION LINES FOR POTS WITH UNDERCUTS

(71) Applicant: SYNERLINK, PUISEUX PONTOISE (FR)

(72) Inventors: Fabien JEGO, ASNIERES SUR SEINE (FR); Christian JACQUEMIN, CONFLANS SAINTE HONORINE (FR); Jean Albert LARMARAUD, VERNEUIL SUR SEINE (FR); Guy CHAUVET, MAISON LAFFITTE (FR)

(21) Appl. No.: 15/363,122

(22) Filed: Nov. 29, 2016

(51) Int. Cl. B65D 1/40; B29C 51/20; B29C 51/38; B29C 51/34; B29C 51/30; A47J 41/00; B65D 43/02; B65D 81/38

(52) U.S. Cl. CPC B65D 1/40; B29C 51/20; B29C 51/38; B29C 51/34; B29K 2105/256; A47J 41/00; B65D 43/02; B65D 81/3813; B29C 51/306

(57) ABSTRACT

Pot with an undercut that includes a bottom wall (5), a side wall (6) that is closed on itself and connected to the bottom wall (5), with an opening providing access to the interior of the pot. The outside surface of the side wall of the pot has a non-symmetrical undercut shape for rotation around the vertical direction (Z). The outside surface has at least one vertical demolding plane (P) such that an undercut value of the pot with respective side ends of the pot, with a maximum side spacing of the outside surface in relation to the vertical demolding plane (P), is less than a maximum undercut value of the pot on the circumference of the outside surface of the pot.

The invention relates to the field of pots with undercuts as well as the manufacture of such pots.

The invention more specifically has as its object a pot with an undercut, an opening mold, and a machine for forming such pots with undercuts as well as a line for producing such pots with undercuts.

In a general manner, a pot such as the one being considered comprises a bottom wall as well as a side wall that is closed on itself and connected to the bottom wall, with the side wall and the bottom wall comprising an inside surface that defines an interior of a pot as well as an outside surface that is opposite to the inside surface. The pot usually comprises an opening that provides access to the pot's interior, said opening being able to be covered by a top closure to insulate the pot's interior. The opening can be surrounded by a collar in such a way as to make it possible to seal the pot by means of an upper closure.

Such a pot is typically designed to contain contents that may or may not be homogeneous, having an overall state that is more or less fluid, optionally comprising more or less solid pieces. Such contents are, for example, a milk product or a dessert, with this list not being limiting.

Thus, for example, the invention finds in particular an application in the production and the distribution of fresh or ultra-fresh dairy products such as yogurts and the like, dessert creams, ice creams and the like, but also cheese products, compotes . . . . The invention is also applied in the production and distribution of products of different natures and/or destinations but that can be considered to be analogous with regard to the shape of their containers.

Such a pot is usually made by forming pots on a production line from a heat-formable plastic sheet, per cycle, per station, and per group of pots. Such a production line thus comprises intake means of a sheet of material for forming from a feed roll. The sheet, rolled up around the roll, is unrolled longitudinally, heated and brought into contact with the upper face of the molds to be shaped. The shaped pot is then treated at different stations that are equipped with means for metering the contents of the pots, tools for welding a capping sheet and final cut-out, for example.

The objects of the invention are in particular such pots with an undercut shape, also called non-demoldable pots. Such pots usually comprise a “neck” in the upper part of the mold, with a size that is smaller than a “stomach” of the pot. Such pots have an attractive appearance for the consumer owing to their particular shape.

To extract such pots from the forming mold, it is necessary to use a forming opening mold that comprises a first and a second sub-mold that are suitable for being moved in a demolding direction between a closed position in which the first sub-mold and the second sub-mold are in mutual contact and an open position in which said sub-molds are separated from one another. Likewise, different tools along a line for producing such pots should be adapted in such a way as to be able to be open; for example, a device for sealing pots following the device for forming pots is usually to be provided with opening counter-electrodes that are suitable for surrounding the collar of the pot.

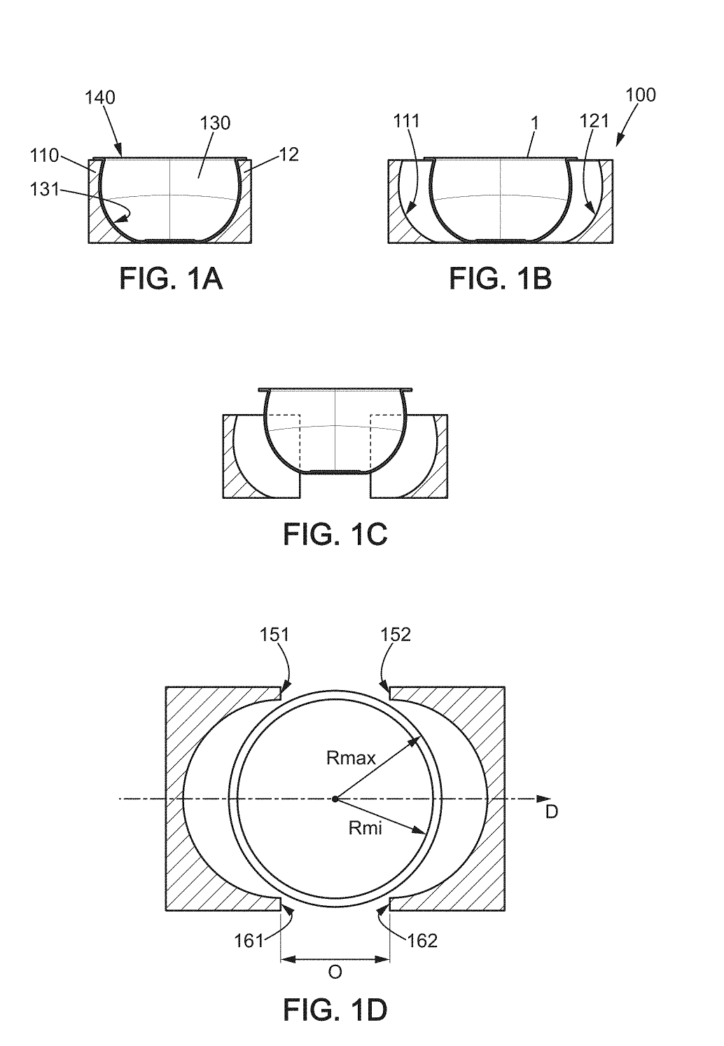

FIGS. 1A to 1D illustrate such pots of the prior art that are formed in opening molds in closed positions (FIG. 1A) and open positions (FIGS. 1B, 1C, and 1D). FIG. 1D illustrates in particular said pots and molds in a top view.

As can be seen in FIG. 1D, the opening mold has a significant longitudinal bulkiness in the open position to make possible the complete demolding of the pot. To prevent interference between the pieces of equipment, in particular between multiple rows of opening molds, a sufficiently large longitudinal space E is actually to be provided between the rows of opening molds of the production line of pots.

The result is a significant loss of portions of the sheet of forming material between the rows of opening molds as well as the capping material, when necessary.

Multiple solutions have been proposed to resolve this problem.

A first solution consists in periodically stretching the sheet in such a way that the sheet portion arranged vertically from the space E has a material thickness that is considerably smaller than the portion used for the forming of the pot, which reduces the amount of material lost.

Another solution is described in, for example, the documents FR 2843094 and EP1275580 and consists in cutting the sheet of forming material, and, if necessary, the capping material, into segments at a rate of as many segments as there are rows of pots to be manufactured. The widths of the segments and the spans separating said segments are adjusted to minimize the loss of material in the different pieces of equipment of the production line.

Still another solution is described in the document WO2011114043, for example, and makes it possible to reduce still further the loss of material in the process of cutting and preparing a single pad of forming material for each pot manufactured.

Such methods impose, however, significant constraints on the production line and are complicated to use. It is necessary to add specific devices for preparation and movement of the segments or pads of forming and capping materials while the various stations for heating, forming, metering, sealing and cutting should all be adapted in a significant manner to the management of segments or pads of materials.

The result is that the production lines of pots with undercuts such as those known from the prior art are particularly expensive. These production lines are also very specific and specialized in the manufacture of a range restricted to a particular type of pots with undercuts.

There is thus a need for lines for producing pots with undercuts that are less expensive and more versatile, while preserving a limited loss of material during the manufacture of pots with undercuts.

For this purpose, the invention has as its first object a pot with an undercut that comprises a bottom wall as well as a side wall that is closed on itself and connected to the bottom wall, with the side wall and the bottom wall comprising an inside surface that defines a pot's interior as well as an outside surface that is opposite to the inside surface, with the pot also comprising an opening that provides access to the pot's interior, said opening being able to be covered by a top closure to insulate the pot's interior, with the opening extending along a horizontal plane and defining a vertical direction, perpendicular to the horizontal plane, passing through a barycenter of the opening, and oriented from the bottom wall to the opening.

The pot is such that the outside surface of the side wall of the pot has a non-symmetrical undercut shape for rotation around the vertical direction, said outside surface having at least one vertical demolding plane, such that an undercut value of the pot with respective side ends of the pot, with a maximum side spacing of the outside surface in relation to the vertical demolding plane, is less than the maximum undercut value of the pot on the circumference of the outside surface of the pot.

According to an embodiment, the vertical demolding plane is defined by the vertical direction and a demolding direction of the horizontal plane, and is such that a side spacing E(t,z)=R(t,z)sin(θ(t,z)) of the outside surface in relation to the demolding direction is

a convex function for t varying from 0 to 1, with a maximum side spacing value of DM1(t1,z)=max_{t∈[0,1]}E(t,z) at a position t1(z) of the first mold opening section, and

a concave function for t varying from 1 to 2, with a maximum side spacing value of DM2(t2,z)=max_{t∈[1,2]}(−E(t,z)) at a position t2(z) of the second mold opening section, where

z is a distance to the bottom wall from a point of the outside surface of the side wall, in the vertical direction,

t∈[0,2] is a circumferential position from a point of the outside surface such that t=0 at an intersection between the outside surface and the demolding direction, t=1 at an intersection between the outside surface and the direction that is opposite to the demolding direction, and t varies from 0 to 2 by passing through a complete circumference of the outside surface around the vertical direction,

θ(t,z) is an angle that is oriented in the horizontal plane in relation to the demolding direction from a point of the outside surface to the position t and the height z, and

R(t,z) is a distance in the vertical direction, in the horizontal plane, from a point of the outside surface to the position t and the height z,

and the outside surface of the side wall has:
A height z1=argmax_{z}(DM1(t1(z),z)) with maximum spacing of the first undercut at the location of the first mold opening section,
A height z1′=argmin_{z>z1}(DM1(t1(z),z)) with minimum spacing of the first undercut at the location of the first mold opening section,
A height z2=argmax_{z}(DM2(t2(z),z)) with maximum spacing of the second undercut at the location of the second mold opening section,
A height z2′=argmin_{z>z2}(DM2(t2(z),z)) with minimum spacing of the second undercut at the location of the second mold opening section.

According to an embodiment:
An overhang of the first undercut at the location of the first mold opening section D1(t1)=R(t1(z1),z1)−R(t1(z1′), z1′) is smaller than a maximum overhang of the first undercut D1ₘₐₓ=maxₜ(R(t,z1))−minₜ(R(t,z1′)) on the circumference of the outside surface of the pot, and
An overhang of the second undercut at the location of the second mold opening section D2(t2)=R(t2(z1),z2)−R(t2(z2′),z2′) is smaller than a maximum overhang of the second undercut D2ₘₐₓ=maxₜ(R(t,z2))−minₜ(R(t,z2′)) on the circumference of the outside surface of the pot.

According to an embodiment, the outside surface of the side wall of the pot is such that
A longitudinal distance from the first undercut on a first half of the pot D1_{long}(t)=F(c1(t),z1)−F(t,z1′) for t∈[0, t1(z1′)] has a local minimum at the location of the first mold opening section t=t1(z1′),
A longitudinal distance from the first undercut on a second half of the pot D1_{long}(t)=F(c2(t),z1)−F(t,z1′) for t∈[t1(z1′),1] has a local minimum at the location of the first mold opening section t=t1(z1′),
A longitudinal distance from the second undercut on a second half of the pot D2_{long}(t)=F(c3(t),z2)−F(t,z2′) for t∈[1,t2(z2′)] has a local minimum at the location of the second mold opening section t=t2(z2′),
A longitudinal distance from the second undercut on a first half of the pot D2_{long}(t)=F(c4(t),z2)−F(t,z2′) for t∈[t2(z2′),2] has a local minimum at the location of the second mold opening section t=t2(z2′),
   where

F(t,z)=R(t,z)cos(θ(t,z)) is a longitudinal spacing of the outside surface of said side wall in the demolding direction,

c1(t) is a longitudinal conversion of the position of the first undercut on a first half of the pot such that sin(θ(c1(t),z1)) R(c1(t),z1)=sin(θ(t,z1′)) R(t,z1′) for t∈[0,t1(z1′)],

c2(t) is a longitudinal conversion of the position of the first undercut on a second half of the pot such that sin(θ(c2(t),z1)) R(c2(t),z1)=sin(θ(t,z1′)) R(t,z1′) for t∈[t1(z1′),1],

c3(t) is a longitudinal conversion of the position of the second undercut on a second half of the pot such that sin(θ(c3(t),z2)) R(c4(t),z2)=sin(θ(t,z2′)) R(t,z2′) for t∈[1,t2 (z2′)], and

c4(t) is a longitudinal conversion of the position of a second undercut on a first half of the pot such that sin(θ(c4(t),z2)) R(c3(t),z2)=sin(θ(t,z2′)) R(t,z2′) for t∈[t2(z2′),2].

According to an embodiment:
A lateral distance from the first undercut D1ₗₐₜ(t)=E(d(t),z1)−E(t,z1′) has a local minimum at the location of the first mold opening section t=t1(z1′), and
A lateral distance from the second undercut D2ₗₐₜ(t)=E(d(t),z2)−E(t,z2′) has a local minimum at the location of the second mold opening section t=t2(z2′),
   where

d1(t) is a lateral conversion of the position of the first undercut such that d1(t)=argmaxₜ′(θ(t′,z1)=θ(t,z1′)), and
d2(t) is a lateral conversion of the position of the second undercut such that d2(t)=argmaxₜ′(θ(t′,z2)=θ(t,z2′)).

According to an embodiment, the distance from the first undercut at the location of the first mold opening section D1(t1) and the distance from the second undercut at the location of the second mold opening section D2(t2) are respectively smaller than one-fourth of the maximum spacing of the first undercut at the location of the first mold opening section DM1(t1,z1) and one-fourth of the maximum spacing of the second undercut at the location of the second mold opening section DM2(t2,z2), preferably respectively less than one-tenth of the maximum spacing of the first undercut at the location of the first mold opening section DM1(t1,z1) and one-fourth of the maximum spacing of the second undercut at the location of the second mold opening section DM2(t2,z2).

According to an embodiment, the first mold opening section and the second mold opening section are essentially opposite to one another in relation to the longitudinal axis.

According to an embodiment, the first mold opening section and the second mold opening section are at right angles in relation to the demolding direction in the vertical direction, in such a way that θ(t1(z),z)=π/2 and θ(t2(z),z)=−π/2 over the entire height z of the pot.

According to an embodiment, the opening is surrounded by a flat collar that extends into the horizontal plane, suitable for making possible the attachment of a top closure to the pot in such a way as to close the pot in an airtight manner.

According to an embodiment, the pot is made of plastic material.

According to an embodiment, the opening of the pot is sealed by a top closure such as a flexible lid made of plastic material.

The invention also has as its object an opening mold that is specially designed to be used in a forming machine to shape at least one pot as described above, comprising a first sub-mold and a second sub-mold, with said sub-molds being adapted to be moved in a demolding direction between a closed position in which the first sub-mold and the second sub-mold are in mutual contact and an open position in which said sub-molds are separated from one another,

with said first sub-mold and second sub-mold forming at least one inside cavity in the closed position of the mold, said at least one cavity being defined by an inside surface of the cavity comprising an inside surface of the first sub-mold and an inside surface of the second sub-mold, with the cavity being open at the location of an upper surface of the opening mold, by an upper opening that extends along a horizontal plane comprising the demolding direction, the upper opening defining a vertical direction of the cavity, perpendicular to the horizontal plane, passing through a barycenter of said upper opening and oriented from a cavity bottom toward the upper opening.

The opening mold is such that in the closed position, the inside surface of the cavity of the opening mold has a non-symmetrical undercut shape for rotation around the vertical direction, said inside surface having a vertical demolding plane comprising the vertical direction as well as the demolding direction and being such that an undercut value of the mold with respective side ends of the inside cavity of the mold, with a maximum side spacing of the inside surface in relation to the vertical demolding plane, is less than a maximum undercut value of the mold on the circumference of the inside surface of the inside cavity.

According to an embodiment, the vertical demolding plane is such that a side spacing E(t,z)=R(t,z)sin(θ(t,z)) of the inside surface of the opening mold in the closed position in relation to the demolding direction is a

convex function for t varying from 0 to 1, with a maximum value of side spacing DM1(t1, z)=max_{t∈[0,1]}E(t,z) at a position t1(z) of the first mold opening section corresponding to a location for contact between respective first opening surfaces of the first sub-mold and the second sub-mold, and a

concave function for t varying from 1 to 2, with a maximum value of side spacing DM2(t2,z)=max_{t∈[1,2]}(−E(t,z)) at a position t2(z) of the second mold opening section corresponding to a location for contact between the respective second opening surfaces of the first sub-mold and the second sub-mold, where

z is a distance to the cavity bottom from a point of the inside surface of the cavity, in the vertical direction,

t∈[0,2] is a circumferential position from a point of the inside surface such that t=0 at an intersection between the inside surface and the demolding direction, t=1 at an intersection between the inside surface and the direction that is opposite to the demolding direction, and t varies from 0 to 2 by passing through a complete circumference of the inside surface around the vertical direction,

θ(t,z) is an angle that is oriented in the horizontal plane in relation to the demolding direction from a point of the inside surface to the position t and the height z, and

R(t,z) is a distance in the vertical direction, in the horizontal plane, from a point of the inside surface to the position t and the height z,

and the inside surface of the cavity has:
A height z1=argmax_{z}(DM1(t1(z),z)) of maximum spacing of the first undercut at the location of the first mold opening section,
A height z1′=argmin_{z>z1}(DM1(t1(z),z)) of minimum spacing of the first undercut at the location of the first mold opening section,
A height z2=argmax,(DM2(t2(z),z)) of maximum spacing of the second undercut at the location of the second mold opening section,
A height z2′=argmin_{z>z2}(DM2(t2(z),z)) of minimum spacing of the second undercut at the location of the second mold opening section.

According to an embodiment:
An overhang of the first undercut at the location of the first mold opening section D1(t1)=R(t1(z1),z1)−R(t1(z1′),z1′) is smaller than a maximum overhang of the first undercut D1ₘₐₓ=maxₜ(R(t,z1))−minₜ(R(t,z1′)) on the circumference of the inside surface of the cavity, and
An overhang of the second undercut at the location of the second mold opening section D2(t2)=R(t2(z1),z2)−R(t2(z2′),z2′) is smaller than a maximum overhang of the second undercut D2ₘₐₓ=maxₜ(R(t,z2))−minₜ(R(t,z2′)) on the circumference of the inside surface of the cavity.

According to an embodiment, the inside surface of the cavity is such that:
A longitudinal distance from the first undercut on a first cavity half D1_{long}(t)=F(c1(t),z1)−F(t,z1′) for t∈[0,t1(z1′)] has a local minimum at the location of the first mold opening section t=t1(z1′),
A longitudinal distance from the first undercut on a second cavity half D1_{long}(t)=F(c2(t),z1)−F(t,z1′) for t∈[t1(z1′),1] has a local minimum at the location of the first mold opening section t=t1(z1′),
A longitudinal distance from the second undercut on a second cavity half D2_{long}(t)=F(c3(t),z2)−F(t,z2′) for t∈[1,t2(z2′)] has a local minimum at the location of the second mold opening section t=t2(z2′),
A longitudinal distance from the second undercut on a first cavity half D2_{long}(t)=F(c4(t),z2)−F(t,z2′) for t∈[t2(z2′),2] has a local minimum at the location of the second mold opening section t=t2(z2′),
   where

F(t,z)=R(t,z)cos(θ(t,z)) is a longitudinal spacing of the inside surface of the cavity in the demolding direction,

c1(t) is a longitudinal conversion of the position of the first undercut on a first cavity half such that sin(θ(c1(t),z1)) R(c1(t),z1)=sin(θ(t,z1′)) R(t,z1′) for t∈[0,t1(z1′)],

c2(t) is a longitudinal conversion of the position of the first undercut on a second cavity half such that sin(θ(c2(t),z1)) R(c2(t),z1)=sin(θ(t,z1′)) R(t,z1′) for t∈[t1(z1′),1],

c3(t) is a longitudinal conversion of the position of the second undercut on a second cavity half such that sin(θ(c3(t),z2)) R(c4(t),z2)=sin(θ(t,z2′)) R(t,z2′) for t∈[1,t2(z2′)], and

c4(t) is a longitudinal conversion of the position of the second undercut on a first cavity half such that sin(θ(c4(t),z2)) R(c3(t),z2)=sin(θ(t,z2′)) R(t,z2′) for t∈[t2(z2′),2].

According to an embodiment:
A lateral distance from the first undercut D1ₗₐₜ(t)=E(d(t),z1)−E(t,z1′) has a local minimum at the location of the first mold opening section t=t1(z1′), and
A lateral distance from the second undercut D2ₗₐₜ(t)=E(d(t),z2)−E(t,z2′) has a local minimum at the location of the second mold opening section t=t2(z2′),
   where

d1(t) is a lateral conversion of the position of the first undercut such that d1(t)=argmaxₜ′(θ(t′,z1)=θ(t,z1′)), and

d2(t) is a lateral conversion of the position of the second undercut such that d2(t)=argmaxₜ′(θ(t′,z2)=θ(t,z2′)).

According to an embodiment, said first sub-mold and second sub-mold form, in the closed position of the mold, a number of inside cavities that are aligned in a longitudinal direction.

According to an embodiment, in the open position, the first sub-mold and the second sub-mold are separated from one another, in the demolding direction, by a distance from the opening O of between one and three times a sum between a maximum undercut distance from the side wall in the demolding direction and a maximum undercut distance from the side wall in the direction that is opposite to the demolding direction.

The invention also has as its object a forming machine that comprises at least one opening mold as described above.

According to an embodiment, the machine comprises a number of opening molds that are aligned for forming at least two rows of molds that each extend in a longitudinal direction that is perpendicular to the demolding direction of said opening molds, each row of molds comprising one or more opening molds that are juxtaposed in the longitudinal direction, said rows of molds being arranged with a spatial period p in the demolding direction, in which said spatial period p is less than one and one-half times a maximum dimension of the inside cavity of an opening mold in the demolding direction.

According to an embodiment, the machine also comprises at least one spacing locking device for pressurized opening molds, with said spacing locking device comprising a first cam and a second cam, said first and second cams respectively coming into contact with the first sub-mold and the second sub-mold of an opening mold in the closed position in such a way as to prevent a relative movement of said sub-molds in the demolding direction, with said first and second cams coming into contact with said first and second sub-molds by a side that is opposite to the upper surface of said opening mold in the vertical direction in such a way as not to exceed the upper surface of said opening mold in the vertical direction.

The invention also has as its object a line for producing pots by forming, comprising a forming machine as described above as well as intake means of a sheet of forming material from at least one feed roll, with the intake means of said sheet of forming material being adapted to bring a portion of the sheet of material into contact with the upper face of the opening molds, said portion of the sheet of material being connected in a continuous manner to the feed roll.

According to an embodiment, said portion of the sheet of material in contact with the upper face of the opening molds covers at least two rows of opening molds of the forming machine.

According to an embodiment, the production line also comprises intake means of a capping sheet from at least one feed roll, with said intake means of the capping sheet being adapted to bring a portion of the capping sheet opposite to the opening of the rows of pots shaped by the pot-forming machine, said pots having, if necessary, their collars connected to one another by the portion of the sheet of materials, said capping sheet portion being connected in a continuous manner to the feed roll,

the line also comprising a suitable device for sealing pots for bringing into contact and sealing said portion of the capping sheet with the collar of the pots.

Finally, the invention has as its object a method for manufacturing pots by forming, in which:
A line for producing pots by forming is arranged as described above,
Starting from the feed roll, a portion of the sheet of material is brought into contact with the upper face of a number of opening molds that are aligned for forming at least two rows of molds that each extend in a longitudinal direction that is perpendicular to the demolding direction of said opening molds, with said portion of the sheet of material being connected in a continuous manner to the feed roll,
The pots are formed in said opening molds.

In relation to the prior art, the advantages of the invention are in particular to reduce the distance from the opening of an opening mold producing a pot according to the invention and therefore making possible the use of conventional intake means of a sheet of forming material, i.e., a device bringing the sheet of forming material in a continuous manner from the feed roll to the opening mold, without thereby generating a significant loss of the sheet of forming material between the rows of opening molds or requiring a precutting of the sheet of forming material. The cost and the complexity of a line for producing pots with undercuts can thus be considerably reduced. The pots with undercuts according to the invention also have the majority of advantages, in particular aesthetic advantages, sought in the pots with undercuts of the prior art. In addition, a line for producing pots without undercuts can be adapted to the production of pots with undercuts in an easy, fast, and low-cost manner.

The figures of the drawings will now be briefly described.

FIGS. 1A, 1B, 1C and 1D illustrate a pot of the prior art as well as an opening mold of the prior art comprising first and second sub-molds during an operation for demolding the pot once it is formed, with the opening mold passing from the closed position (FIG. 1A) to the open position (FIGS. 1B, 1C, 1D).

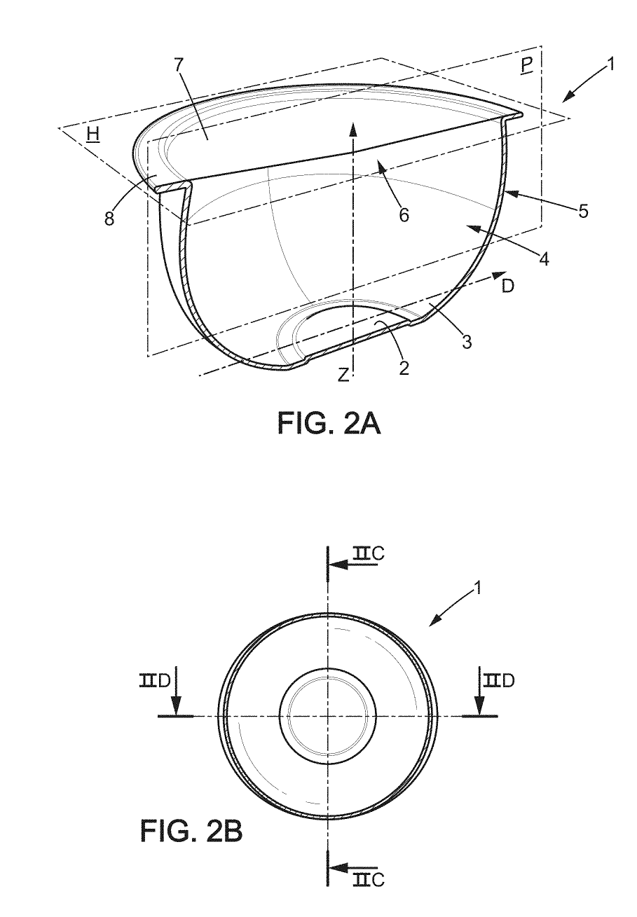

FIGS. 2A, 2B, 2C and 2D illustrate different sections of a pot according to an embodiment of the invention.

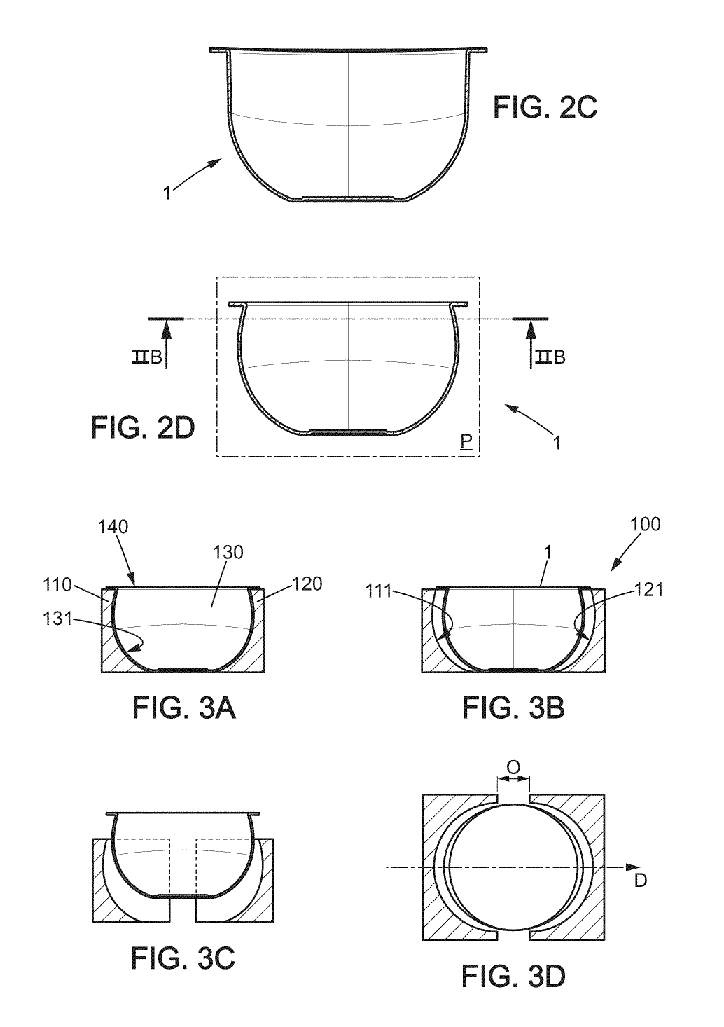

FIGS. 3A, 3B, 3C and 3D show the pot of FIGS. 2A-2D as well as an opening mold according to an embodiment of the invention during an operation for demolding the pot once it is formed, with the opening mold passing from the closed position (FIG. 3A) to the open position (FIGS. 3B, 3C, 3D).

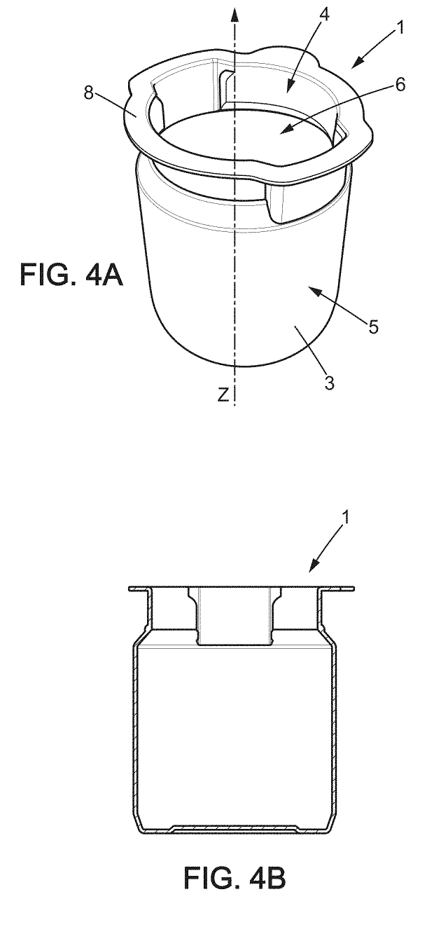

FIGS. 4A, 4B and 4C illustrate a variant of the pot of FIGS. 2A-2D in perspective view (FIG. 4A) and in two sections (FIGS. 4B and 4C).

FIG. 4D illustrates a first sub-mold of an opening mold according to the invention that is specially designed to form the pot of FIGS. 4A-4C.

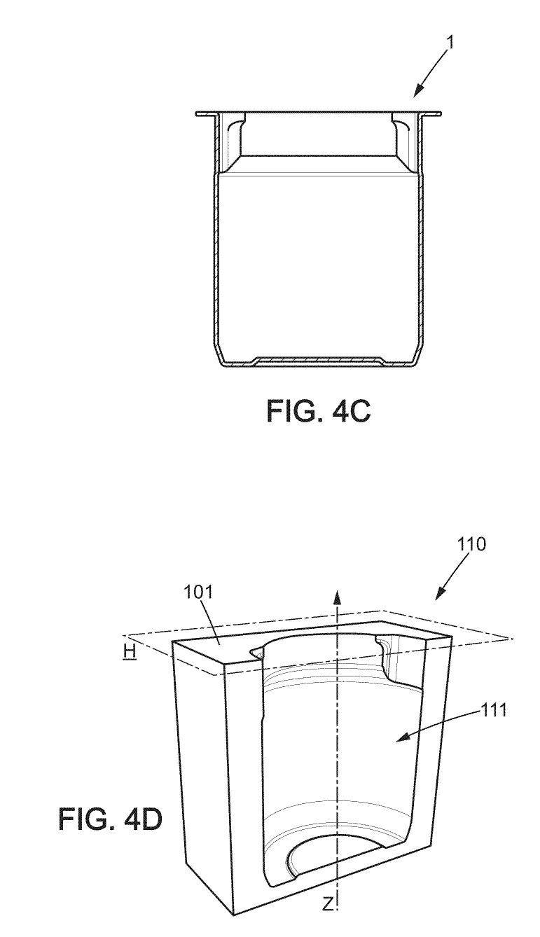

FIGS. 5A, 5B, 5C and 5D illustrate another variant of the pot of FIGS. 2A-2D in three sections (FIGS. 5A, 5B and 5C) and in perspective view (FIG. 5D).

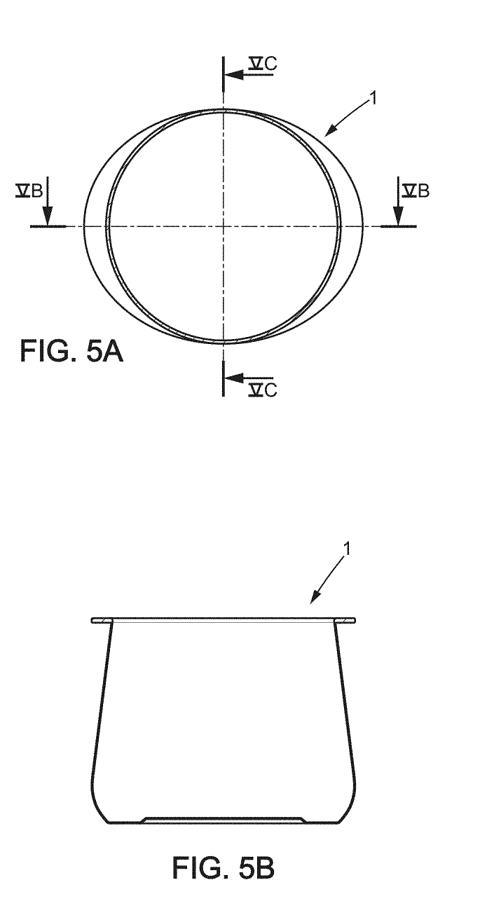

FIG. 6A is a curve that shows the side spacing E(t,z) of the outside surface of a pot according to an embodiment of the invention or of the inside surface of a cavity of an opening mold according to an embodiment of the invention, for a fixed height z and based on the position t on the circumference of the outside surface of the side wall, and FIG. 6B illustrates the same on a different coordinate system.

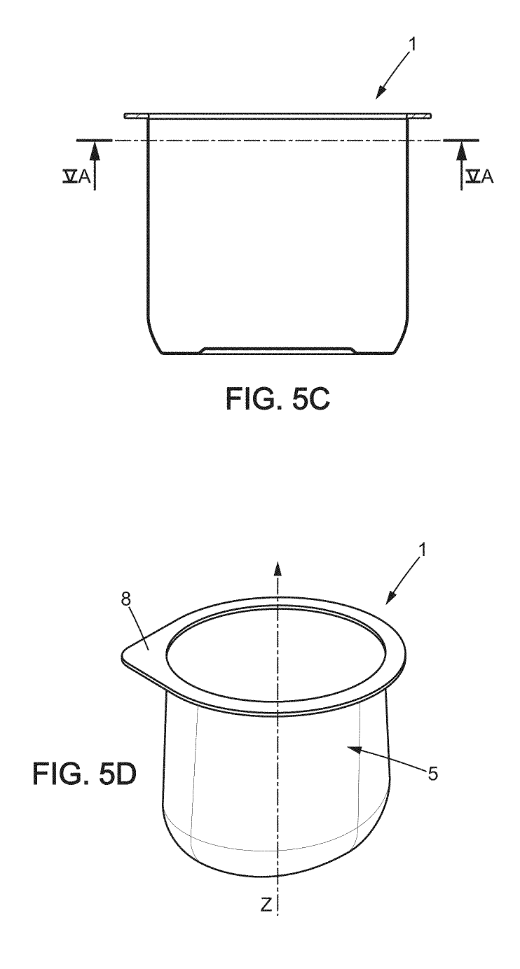

FIG. 7A illustrates a section of a pot according to the invention that is similar to the section of FIG. 2B, as well as a circle in dotted form with a radius that is equal to the maximum radius of the side wall of the pot.

FIG. 7B is a curve showing the overhang of the first undercut of the outside surface of a pot according to an embodiment of the invention or of the inside surface of a cavity of an opening mold according to an embodiment of the invention, based on the position t on one-half of the circumference of the outside surface of the pot or of the inside surface of the cavity of the opening mold. The curve in dotted form of FIG. 7B shows the overhang of the first undercut of the outside surface of a pot according to the prior art of FIGS. 1A-1D or of the inside surface of a cavity of an opening mold according to the prior art of FIGS. 1A-1D.

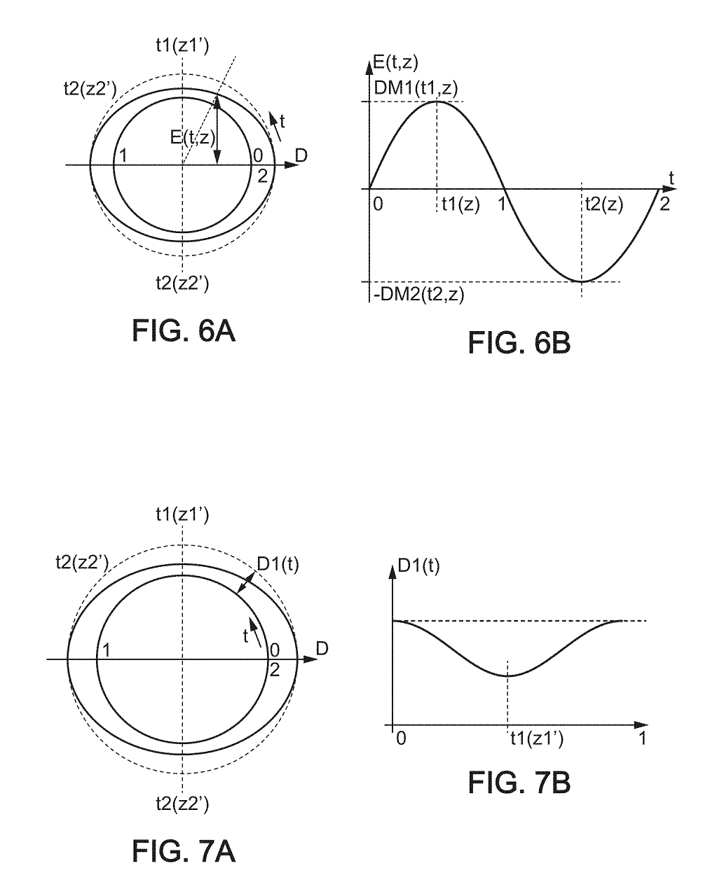

FIG. 8A illustrates a pot section that is similar to the section of FIG. 7A, and FIG. 8B is a curve that shows the longitudinal distance from the first undercut based on the position t on a first half of a pot according to an embodiment of the invention or a cavity of an opening mold according to an embodiment of the invention. The curve in dotted form of FIG. 8B shows the longitudinal distance from the first undercut of a pot according to the prior art of FIGS. 1A-1D or of the inside surface of a cavity of an opening mold according to the prior art of FIGS. 1A-1D.

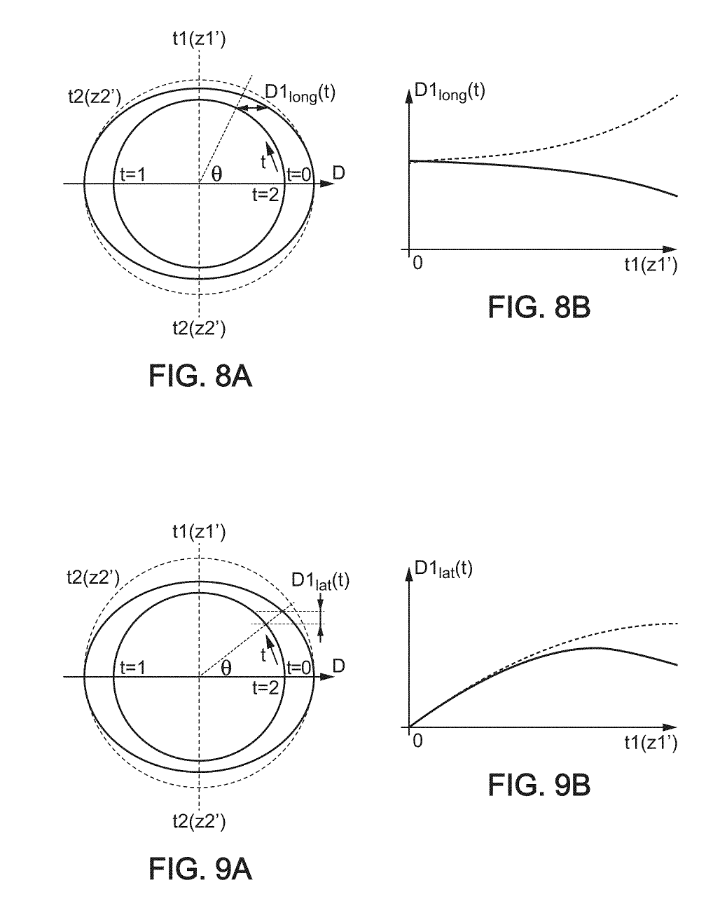

FIG. 9A illustrates a pot section that is similar to the section of FIG. 7A, and FIG. 9B is a curve that shows the lateral distance from the first undercut of a pot according to an embodiment of the invention or a cavity of an opening mold according to an embodiment of the invention. The curve in dotted form of FIG. 9B shows the lateral distance from the first undercut of a pot according to the prior art of FIGS. 1A-1D or of the inside surface of a cavity of an opening mold according to the prior art of FIGS. 1A-1D.

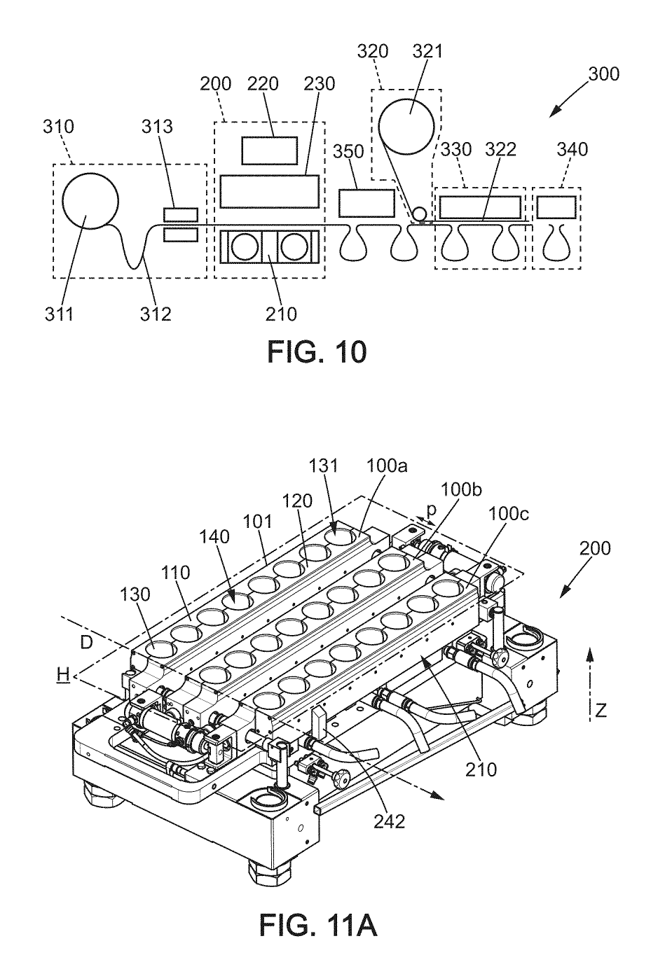

FIG. 10 illustrates a line for producing pots by forming according to an embodiment of the invention.

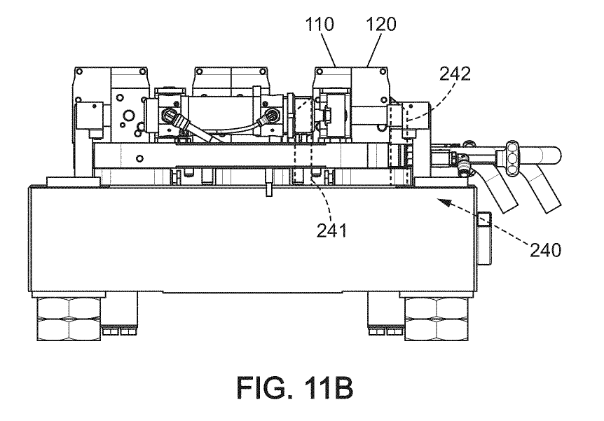

FIGS. 11A and 11B are respectively perspective and side views of a forming machine according to an embodiment of the invention.

Below, a detailed report on several embodiments of the invention coupled with examples and a reference to the drawings.

FIG. 1A illustrates a pot with an undercut shape according to an example of the prior art. Unlike demoldable pots that usually have a cylindrical shape with a more or less complex directing curve (circle or curvilinear square with rounded corners) and an often vertical generatrix, the generatrix of the side wall of an undercut pot in the prior art can have a more complex shape, for example an arc.

As can be seen in FIG. 1A, the pot 1 has a symmetrical rotational shape around a vertical direction Z. More specifically, the pot 1 comprises a bottom wall 2 as well as a side wall 3 that is closed on itself and connected to the bottom wall 2. The side wall 3 and the bottom wall 2 comprise an inside surface 4 as well as an outside surface 5 that is opposite to the inside surface 4. The inside surface 4 is formed in part by an inside surface of the side wall and an inside surface of the bottom wall. The inside surface 4 of the pot defines an interior of the pot 5 that is suitable for receiving the contents of the pot. The pot also comprises an opening 6 providing access to the interior of the pot 5. The opening 6 can be covered by a top closure 7 for insulating the interior of the pot 5. The top closure 7 is, for example, a flexible lid made of plastic material.

The opening 6 extends along a horizontal plane H and further defines a vertical direction Z, perpendicular to the horizontal plane H and passing through a barycenter of the opening 6. The vertical direction Z is oriented from the bottom wall 2 to the opening 6.

In particular, the opening 6 can be surrounded by a flat collar 8 that extends into the horizontal plane H. The collar 8 can be adapted for making possible the attachment of the top closure 7 to the pot 1 in such a way as to close the pot 1 in an airtight manner.

The pot is made of, for example, plastic material, and can in particular be made by heat-forming a plastic sheet as presented in detail below.

As can be seen in FIGS. 1A to 1C, the pot 1 is shaped, for example, by means of an opening mold 100. Such an opening mold 100 comprises a first sub-mold 110 and a second sub-mold 120 that are suitable for being moved in a demolding direction D of the opening mold between a closed position, illustrated in FIG. 1A, and an open position, illustrated in FIGS. 1B and 1C.

In the closed position of the opening mold 100, the first sub-mold 110 and the second sub-mold 120 together form at least one inside cavity 130 of the opening mold.

The inside cavity 130 is defined by an inside surface of the cavity 131 that comprises an inside surface of the first sub-mold 111 and an inside surface of the second sub-mold 121. The cavity 130 is open at the location of an upper surface 101 of the opening mold 100, by an upper opening 140.

The upper opening 140 extends along a horizontal plane H that comprises the demolding direction D of the mold. The upper opening 140 also defines a vertical direction of the cavity Z, perpendicular to the horizontal plane H and passing through a barycenter of the upper opening 140. The vertical direction Z is oriented from a cavity bottom 132 to the upper opening 140 of the opening mold 100.

In the closed position, the first sub-mold 110 and the second sub-mold 120 are in mutual contact, on the one hand, at the location of the respective first opening surfaces 111, 121, and, on the other hand, at the location of the respective second opening surfaces 112, 122. The first opening surfaces 111, 121 and the second opening surfaces 112, 122 are placed on either side of the upper opening 140 of the opening mold 100.

In the open position, the first sub-mold 110 and the second sub-mold 120 are separated from one another by a distance from the opening O that is sufficient to make it possible to extract the formed pot from the mold by relatively moving the mold in relation to the pot in the vertical direction Z.

The pot that is illustrated in FIGS. 1A to 1D has a maximum radius Rmax at the location of the “stomach” of said pot and a minimum radius Rmin at the location of the “neck” of said pot.

As can be seen in FIGS. 1B to 1D, because of the usual shape of the pot with an undercut, the distance from opening O is considerably greater than the undercut overhang Dc=Rmax−Rmin. More specifically, for a pot with a rotational symmetry such as the one illustrated in FIGS. 1A to 1D, the distance from the opening O can be expressed as 0=2\sqrt{Rmax²−Rmin²}.

Thus, when the maximum radius of the pot, Rmax, becomes large with respect to the radius of the neck of the pot, Rmin, the distance from the opening O tends toward a value that is close to the maximum diameter of the pot, Rmax. Actually, as can be seen in FIG. 1D, it is then necessary to provide a spacing E that is close to the size of a pot and therefore much larger than the value of the undercut overhang Dc=Rmax−Rmin of the pots between the rows of opening molds.

One of the objectives of this invention is to provide a pot that makes it possible to reduce the distance from the opening O between the sub-molds of the opening mold in the open position and therefore the spacing E between the rows of opening molds.

For this purpose, FIG. 2A illustrates a pot 1 according to an embodiment of the invention. Such a pot 1 has the same constituent elements as the pot of the prior art that is illustrated in FIGS. 1A-1D, a bottom wall 2, a side wall 3, an inside surface 4 as well as an outside surface 5 that is opposite to the inside surface 4. The inside surface 4 of the pot also defines an interior of a pot 5, and the pot here also comprises an opening 6 that provides access to the interior of the pot 5 and can be covered by a top closure 7 for insulating the interior of the pot 5. The pot also being able to comprise a collar 8 as described above.

The shape of the outside surface 5 of the side wall 3 of the pot 1 according to the invention is, however, different from the shape of the outside surface 5 of the side wall 3 of the pot 1 of FIGS. 1A to 1D.

More specifically, the outside surface 5 of the side wall 3 of the pot 1 according to the invention has a non-symmetrical undercut shape for rotation around the vertical direction Z. The outside surface 5 thus has at least one vertical demolding plane P, illustrated in FIGS. 2A and 2D, such that an undercut value of the pot 1 with respective side ends 1a, 1b of the pot, with a maximum side spacing of the outside surface 5 in relation to the vertical demolding plane P, is less than a maximum undercut value of the pot 1 on the circumference of the outside surface 5 of the pot 1.

In a general manner, “an undercut value” is defined as a difference between a bulkiness of the pot in the area of the neck of the pot and a bulkiness of the pot in the area of the stomach of the pot.

This particular form of the outside surface 5 of the pot 1 makes it possible to simplify the demolding of the pot and to reduce the distance from the opening of the opening mold O, while preserving a significant undercut offering the expected advantages of a pot with an undercut, in particular from the standpoint of the outside appearance of said pot.

This will now be explained in more detail with reference to FIGS. 2A-2D and 3A-3D. As illustrated in FIG. 2A, the vertical demolding plane P is defined by the vertical direction Z and a demolding direction D of the horizontal plane H.

A side spacing E(t,z) of the outside surface 5 in relation to the demolding plane P can then be defined as E(t,z)=R(t,z)sin(θ(t,z)) where
z is a distance to the bottom wall 2, for example to the outside surface of the bottom wall, from a point of the outside surface 5 of the side wall, in the vertical direction (Z), and
t∈[0,2] is a circumferential position from a point of the outside surface 5 such that

t=0 at an intersection between the outside surface 5 and the demolding direction D,

t=1 at an intersection between the outside surface 5 and the direction that is opposite to the demolding direction D, and

t varies from 0 to 2 in passing through a complete circumference of the outside surface 5 around the vertical direction Z.

It is also possible to define cylindrical coordinates (θ(t,z),z),z) of the outside surface points 5 in the reference point formed by the vertical direction Z and the demolding direction D where

θ(t,z) is an angle that is oriented in the horizontal plane H in relation to the demolding direction D from a point of the outside surface to the position t and the height z, and

R(t,z) is a distance to the vertical direction Z, in the horizontal plane H, from a point of the outside surface to the position t and the height z.

The side spacing E(t,z) based on t for a fixed height z is illustrated in FIG. 6. The side spacing is more specifically such that for every fixed height z, E(t,z) is:

convex for t varying from 0 to 1, with a maximum side spacing value DM1(t1,z)=max_{t∈[0,1]}E(t,z) at a position t1(z) of the first mold opening section, and

concave for t varying from 1 to 2, with a maximum side spacing value DM2 (t2,z)=max_{t∈[1, 2]}(−E(t,z)) at a position t2(z) of the second mold opening section.

In this manner, it is possible to demold the pot with an opening mold 100 as illustrated in FIGS. 3A-3D comprising a first sub-mold 110 and a second sub-mold 120 moved in the demolding direction (D) between the closed position and the open position and such that, when the first sub-mold 110 and the second sub-mold 120 are in mutual contact,

the first respective opening surfaces 151, 152 of the sub-molds are in contact with the outside surface 5 of the pot at the location of the positions t1(z) of the first mold opening section for every height z, and

the second respective opening surfaces 161, 162 of the sub-molds are in contact with the outside surface 5 of the pot at the location of the positions t2(z) of the second mold opening section for every height z.

In a particular embodiment of the invention, the first mold opening section and the second mold opening section can be essentially opposite in relation to the longitudinal axis Z.

The first mold opening section and the second mold opening section can also be arranged at right angles in relation to the demolding direction D in the vertical direction Z, i.e., θ(t1(z),z)=π/2 and θ(t2(z),z)=π/2.

There are also defined on the outside surface of the side wall:
A height z1=argmax_{z}(DM1(t1(z),z)) of maximum spacing of the first undercut at the location of the first mold opening section,
A height z1′=argmin_{z>z1}(DM1(t1(z),z)) of minimum spacing of the first undercut at the location of the first mold opening section,
A height z2=argmax_{z}(DM2(t2(z),z)) of maximum spacing of the second undercut at the location of the second mold opening section,
A height z2′=argmin_{z>z2}(DM2(t2(z),z)) of minimum spacing of the second undercut at the location of the second mold opening section.
«zi=argmax_{z}(f(z))» for a function f(z) is defined as the value zi of z for which f(z) reaches its highest value. If the function f(z) reaches its maximum for a set of multiple values {zj, zk, zl} of z, it will then be assumed that zi is the highest value in said set, or zi=max(argmax_{z}(f(z))). For the sake of brevity, simply zi=argmax_{z}(f(z)) will be used in this description.

In a similar way, «zi=argmin_{z>zj}(f(z))» for a function f(z) is defined as the value zi of z for which f(z) reaches its lowest value above zj. Here also, if the function f(z) reaches its minimum for a set of multiple values {zj, zk, zl} of z, it will then be assumed that zi is the highest value in said set, or zi=max(argmin_{z>zj}(f(z))). For the sake of brevity, simply zi=argmin_{z>zj}(f(z)) will be used in this description.

The heights z1 and z2 thus correspond to the height of the «stomach» of the pot 1, respectively in the area of the first mold opening section and the second mold opening section.

The heights z1′ and z2′ correspond to the height of the «neck» of the pot 1, respectively in the area of the first mold opening section and the second mold opening section.

As can be understood by examining FIGS. 2A and 3D in particular, the form of the outside surface 5 of the pot 1 with the heights z1 and z1′ sets a first constraint on the distance from the opening O between the first and second sub-molds of an opening mold at the location of the first mold opening section. Likewise, the shape of the outside surface 5 of the pot 1 with the heights z2 and z2′ sets a second constraint on the distance from the opening O between the first and second sub-molds of an opening mold at the location of the second mold opening section.

FIGS. 7A-7B illustrate how a pot that has a side wall according to the invention makes it possible to loosen said constraints for reducing the distance from the opening O between the first and second sub-molds.

Thus, the pot according to the invention can be such that an overhang of the first undercut at the location of the first mold opening section D1(t1)=R(t1(z1),z1)−R(t1(z1′),z1′) is smaller than a maximum overhang of the first undercut D1ₘₐₓ=maxₜ(R(t,z1))−minₜ(R(t,z1′)) on the circumference of the outside surface of the pot.

In a similar manner, an overhang of the second undercut at the location of the second mold opening section D2(t2)=R(t2(z1),z2)−R(t2(z2′),z2′) may be smaller than a maximum overhang of the second undercut D2ₘₐₓ=maxₜ(R(t,z2))−minₜ(R(t,z2′)) on the circumference of the outside surface of the pot.

In particular, the distance from the first undercut at the location of the first mold opening section D1(t1) may be less than one-fourth of the maximum spacing of the first undercut at the location of the first mold opening section DM1(t1,z1). Likewise, the distance from the second undercut at the location of the second mold opening section D2(t2) may also be less than one-fourth of the maximum spacing of the second undercut at the location of the second mold opening section DM2(t2,z2).

In a particular embodiment, said distances from the first undercut to the location of the first mold opening section D1(t1) and the distance from the second undercut to the location of the second mold opening section D2(t2) may be respectively less than one-tenth of the maximum spacing from the first undercut to the location of the first mold opening section DM1(t1,z1) and one-fourth of the maximum spacing from the second undercut to the location of the second mold opening section DM2(t2,z2).

In particular, it can be seen in FIG. 7B that this is a curve representing the overhang of the first undercut of the outside surface of a pot according to an embodiment of the invention or of the inside surface of a cavity of an opening mold according to an embodiment of the invention, based on the position t on one-half of the circumference of the outside surface of the pot or the inside surface of the cavity of the opening mold.

The curve in dotted form of FIG. 7B shows in particular the overhang of the first undercut of the outside surface of a pot according to the prior art of FIGS. 1A-1D or of the inside surface of a cavity of an opening mold according to the prior art of FIGS. 1A-1D.

Thanks to this geometry, the distance from the opening O is thus also reduced between the first and second sub-molds of an opening mold that forms the pot 1.

An alternative way of loosening said constraints on the distance from the opening O between the first and second sub-molds is illustrated in FIGS. 8A-8B.

More specifically, the longitudinal spacing of the outside surface 5 of the side wall 3 of the pot 1 in the demolding direction D, which is provided by F(t,z)=R(t,z)cos(θ(t,z)), is considered here.

In this embodiment of the invention, the outside surface 5 of the side wall 2 of the pot is stressed on the first half of the pot as well as on the second half of the pot, respectively corresponding to the portion of the pot received by a first sub-mold and a second sub-mold of an opening mold that forms the pot, and in particular stressed in the area of the first and second mold opening sections.

Thus, a longitudinal distance from the first undercut to a first half of the pot D1_{long}(t)=F(c1(t),z1)−F(t,z1′) for t∈[0,t1(z1′)] has a local minimum at the location of the first mold opening section t=t1(z1′), where c1(t) is a longitudinal conversion of the position of the first undercut on a first half of the pot such that sin(θ(c1(t),z1)) R(c1(t),z1)=sin(θ(t,z1′)) R(t,z1′) for t∈[0,t1(z1′)].

Because of the convex shape of the lateral spacing E(t,z) for t varying from 0 to t1(z) and for every fixed height z, the longitudinal conversion of the position of the first undercut is well defined for every t∈[0,t1(z1′)].

Likewise, a longitudinal distance from the first undercut on a second half of the pot D1_{long}(t)=F(c2(t),z1)−F(t,z1′) for t∈[t1(Z1′),1] has a local minimum at the location of the first mold opening section t=t1(z1′) where c2(t) is a longitudinal conversion of the position of the first undercut on a second half of the pot such that sin(θ(c2(t),z1)) R(c2(t),z1)=sin(θ(t,z1′)) R(t,z1′) for t∈[t1(Z1′),1].

Here also, because of the convex shape of the side spacing E(t,z) for t varying from t1(z) to 1 and for every fixed height z, the longitudinal conversion of the position of the first undercut is well defined for every t∈[t1(z1′),1].

A longitudinal distance from the second undercut on a second half of the pot D2_{long}(t)=F(c3(t),z2)−F(t,z2′) for t∈[1,t2(z2′)] has a local minimum at the location of the second mold opening section t=t2(z2′) where c4(t) is a longitudinal conversion of the position of the second undercut on a second half of the pot such that sin(θ(c3(t),z2)) R(c4(t),z2)=sin(θ(t,z2′)) R(t,z2′) for t∈[1,t2(z2′)].

Because of the concave shape of the side spacing E(t,z) for t varying from to 1 t2(z) and for every fixed height z, the longitudinal conversion of the position of the second undercut is well defined for every t∈[1,t2(z2′)].

Finally, a longitudinal distance from the second undercut on a first half of the pot D2_{long}(t)=F(c4(t),z2)−F(t,z2′) for t∈[t2(z2′),2] also has a local minimum at the location of the second mold opening section t=t2(z2′) where c4(t) is a longitudinal conversion of the position of the second undercut on a first half of the pot such that sin(θ(c3(t),z2)) R(c3(t),z2)=sin(θ(t,z2′)) R(t,z2′) for t∈[t2(z2′),2].

Here also, because of the concave shape of the side spacing E(t,z) for t varying from t2(z) to 2 and for every fixed height z, the longitudinal conversion of the position of the second undercut is well defined for every t∈[t2(z2′), 2].

FIG. 8B illustrates the longitudinal distance from a first undercut based on the position t on a first half of a pot according to an embodiment of the invention or a cavity of an opening mold according to an embodiment of the invention. The curve in dotted form of FIG. 8B shows the longitudinal distance from a first undercut of a pot according to the prior art of FIGS. 1A-1D or of the inside surface of a cavity of an opening mold according to the prior art of FIGS. 1A-1D.

As can be seen in FIG. 3D, such a form of the outside surface 5 of the side wall 2 of the pot makes it possible to reduce the distance from the opening O between the first and second sub-molds.

Also, another way of loosening said constraints on the distance from the opening 0 between the first and second sub-molds is illustrated in FIGS. 9A-9B.

This time, the side spacing of the outside surface 5 of the side wall 3 of the pot 1 is considered again in the demolding direction D, which is provided by E(t,z)=R(t,z)sin(θ(t,z)).

In this embodiment of the invention, the outside surface 5 of the side wall 2 of the pot is stressed in the area of the first and second mold opening sections in the following manner.

A lateral distance from the first undercut D1ₗₐₜ(t)=E(d1(t),z1)−E(t,z1′) has a local minimum at the location of the first mold opening section t=t1(z1′) where d1(t) is a lateral conversion of the position of the first undercut such that d1(t) is a higher value of [0,1] such that θ(d1(t),z1)=θ(t,z1′). In contrast to the preceding embodiment that is defined by the longitudinal distance, it is possible to obtain multiple values t′ such that θ(t′,z1)=θ(t,z1′)); d1(t) is therefore the highest value of the interval [0,1] that verifies this equality.

In addition, a lateral distance from the second undercut D2ₗₐₜ(t)=E(d1(t),z2)−E(t,z2′) has a local minimum at the location of the second mold opening section t=t2(z2′) or d2(t) is a lateral conversion of the position of the second undercut such that d2(t) is a higher value of [1,2] such that θ(d2(t), z2)=θ(t,z2′). Here, also, it is possible to obtain multiple values t′ such that θ(t′,z2)=θ(t,z2′)); d2(t) is thus the highest value of the interval [1,2] that verifies this equality.

This is shown in particular in FIG. 9B, which is a curve of the lateral distance from the first undercut of a pot according to an embodiment of the invention or a cavity of an opening mold according to an embodiment of the invention based on the circumferential position t. The curve in dotted form of FIG. 9B shows the lateral distance from the first undercut of a pot according to the prior art of FIGS. 1A-1D or of the inside surface of a cavity of an opening mold according to the prior art of FIGS. 1A-1D.

The embodiments of the pots that are described above make it possible in particular to reduce the distance from the opening between the sub-molds of an opening mold used for forming said pot.

Thus, in at least some of these embodiments, it is possible to form the pot with an opening mold such that, in the open position, the first sub-mold and the second sub-mold are separated from one another, in the demolding direction D, by a distance from the opening O of between one and three times a total spacing of the undercut.

Total spacing of the undercut is defined as a sum between a maximum distance from the undercut of the side wall in the demolding direction D and a maximum distance from the undercut of the side wall in the direction that is opposite to the demolding direction D.

FIGS. 4A-4C illustrate a first variant of the pot of FIGS. 2A-2D. FIG. 4D illustrates a sub-mold of an opening mold that makes it possible to shape the pot of FIGS. 4A-4C. FIGS. 5A-5D illustrate a second variant of the pot of FIGS. 2A-2D. The variants of FIGS. 4A-4C and 5A-5D are provided by way of indication; other variants can quite obviously be considered.

The invention also has as its object an opening mold 100 that is specially designed to be used in a forming machine for shaping at least one pot as described above.

The opening mold 100 comprises a first and second sub-molds 110, 120 as described above, such that, in the closed position of the opening mold 100, the first sub-mold 110 and the second sub-mold 120 together form at least one inside cavity 130 that is defined by an inside surface of the cavity 131 and that is open at the location of an upper surface 101 of the opening mold 100, by an upper opening 140 that extends along a horizontal plane H. The demolding direction D of the mold and the vertical direction of the cavity are defined and oriented as indicated above and illustrated in, for example, FIG. 4C.

The opening mold according to the invention is in particular such that the inside surface of the cavity 131 of the opening mold in the closed position has a non-symmetrical undercut shape for rotation around the vertical direction Z of the opening mold.

More specifically, the inside surface has a vertical demolding plane P that comprises the vertical direction Z of the mold as well as the demolding direction of the mold D and is such that an undercut value of the opening mold at the respective side ends of the inside cavity of the mold, with the maximum side spacing of the inside surface in relation to the vertical demolding plane P, is less than a maximum undercut value of the opening mold on the circumference of the inside surface of the inside cavity of the opening mold.

With the opening mold being specially designed to form the pot 1 that was just described, the inside surface 131 of the inside cavity 130 has a geometric shape that is similar to the one that was just described for the outside surface 5 of the side wall 3 of the pot 1.

The elements that are presented in detail above, relative to the outside surface of the side wall of the pot, are therefore also applicable to the mold, by replacing the “outside surface” of the side wall of the pot by the “inside surface” of the cavity of the opening mold in the closed position.

Reference is therefore made to the geometric characteristics that are presented in detail above and that will not be repeated here.

Furthermore, relative to the shape of the inside surface of the opening mold in the closed position, it will be noted that the first mold opening section corresponds in the case of the mold to a location for contact between the first respective opening surfaces 151, 152 of the first sub-mold and the second sub-mold.

Likewise, the second mold opening section corresponds, in the case of the mold, to a location for contact between the second respective opening surfaces 161, 162 of the first sub-mold and the second sub-mold.

In addition, the first half of the pot and the second half of the pot, in the case of the outside surface, correspond respectively, in the case of the mold, to a first half of the inside cavity and to a second half of the inside cavity.

In this manner, the opening mold is such that, in the open position, the first sub-mold and the second sub-mold are separated from one another, in the demolding direction D, by a distance from the opening O that is between one and three times a total spacing of the undercut.

Total spacing of the undercut is defined as a sum between a maximum distance from the undercut of the side wall in the demolding direction D and a maximum distance from the undercut of the side wall in the direction that is opposite to the demolding direction D.

The opening mold 100 is designed to be used in a forming machine 200 for shaping one or more pot(s) 1 as described above.

Thus, the first and second sub-molds 110, 120 can in particular form, in the closed position of the mold 100, a number of n inside cavities 130a, 130b, . . . 130n, aligned in a longitudinal direction X. The longitudinal direction X can in particular be perpendicular to the demolding direction D of the opening molds.

In this manner, it is possible to manufacture in a single operation a complete row of pots 1 with a single opening mold 100.

Multiple such rows of pots 1 can be manufactured by a forming machine 200 as will now be described.

A forming machine 200 according to the invention is illustrated in, for example, FIG. 10. As indicated above, such a forming machine 200 comprises at least one opening mold 100.

Advantageously, this forming machine 200 comprises a number of opening molds 100a, 100b, . . . , 100m.

The opening and closing of the m opening molds 100 is controlled in a synchronous manner by a forming control device 220. The mold forming machine 200 further comprises counter-molds and punches 230 for shaping the pots 1 in the opening molds 100, with said counter-molds and punches 230 being advantageously also controlled in a synchronous manner with the opening and closing of the m opening molds 100 by the forming control device 220.

Such synchronization can be done in a mechanical manner by connecting rods or cams connecting the opening molds 100 to the counter-molds and punches 230, or it can be done in an electronic manner by control motors that are separate from the opening molds 100 and counter-molds and punches 230 as well as sensors and an electronic synchronization unit.

It is thus possible, in a forming step, to shape n*m pots using n*m inside cavities of the opening molds 100.

The opening molds 100a, 100b, . . . , 100m are advantageously arranged in such a way that their demolding directions D are parallel to one another and thus define a longitudinal direction X of the forming machine 200, perpendicular to said demolding directions D. The opening molds 100a, 100b, . . . , 100m are arranged to form at least two rows of molds 210 that each extend in the longitudinal direction X of the forming machine. Each row of molds 210 comprises one or more opening molds 100 that are juxtaposed and aligned in the longitudinal direction X.

As can be seen in FIG. 11A, the rows of molds 210 are arranged with a spatial period p in the demolding direction D. The spatial period p is in particular less than one and one-half times a maximum dimension of the inside cavity 130 of an opening mold in the demolding direction D.

Actually, because of the limited distance from the opening O of the opening molds 100, it is possible to position the rows of molds 210 with a relative distance in the demolding direction D, i.e., a spatial period p, reduced in relation to the prior art.

In this manner, it is possible to use a single and continuous sheet of forming material, covering all of the n*m inside cavities of the opening molds 100, for forming n*m pots in a forming step.

The use of accompanying devices for precutting the sheet of forming materials is thus avoided.

As is illustrated in FIG. 11B, the forming machine 200 can also comprise at least one locking device 240 for separating opening molds that are put under pressure, in particular a locking device 240 for each opening mold 100. Said at least one locking device 240 for separating opening molds can be controlled in particular by the control device of the molds 220.

The locking device 240 for separating can comprise, for example, a first cam 241 and a second cam 242, respectively coming into contact with the first sub-mold 110 and the second sub-mold 120 when the opening mold is in the closed position.

The first cam 241 and the second cam 242 are suitable for, when they are in contact with said sub-molds 110, 120, preventing a relative movement of said sub-molds 110, 120 in the demolding direction D.

As can be seen in FIG. 11B, the first and second cams 241, 242 come into contact with the sub-molds 110, 120 by a side that is opposite to the upper surface 101 of the opening mold 100 in the vertical direction Z in such a way as not to exceed said upper surface 101 of said mold 100 in the vertical direction Z.

The forming machine 200 that is described above may also be integrated into a line 300 for producing pots by forming according to the invention, for example as illustrated in FIG. 10.

Such a production line comprises a forming machine 200 as well as intake means 310 of a sheet of forming material starting from at least one feed roll 311.

The intake means 310 of the sheet of forming material are suitable for bringing a portion of the sheet of material 312 into contact with the upper face 101 of the opening molds 100 in such a way that the portion of the sheet of material 312 is connected in a continuous manner to the feed roll 311.

Thus, in particular, the intake means 310 of the sheet of forming material in the opening molds 100 of the forming machine 200 do not cut said sheet of forming material.

Furthermore, as illustrated in FIG. 10, the portion of the sheet of material 312 that is brought into contact with the upper face 101 of the opening molds 100 covers at least at least [sic] two rows 210 of opening molds 100 of the forming machine 200.

As indicated above, because of the limited distance from the opening O of the opening molds 100, the rows of molds 210 are close to one another in the demolding direction D, and it is possible to use a single and continuous sheet of forming material for forming n*m pots in a forming step without resorting to accompanying devices for precutting the sheet of forming material.

A heating device 213 can be placed upstream from the forming machine 200 for preheating the sheet of forming material for the forming operation.

The line 300 for producing pots can also comprise intake means 320 of a capping sheet starting from at least one feed roll 321 of the capping sheet.

In a manner that is similar to what was described relative to the sheet of forming material, the intake means 320 of the capping sheet are suitable for bringing a portion of the capping sheet 322 opposite to the openings 3 of pots 1 that are shaped by the pot-forming machine of the production line.

The production line then advantageously comprises a device for sealing pots 330 that is suitable for putting into contact and sealing said portion of the capping sheet 322 with the collar 6 of the pots 1.

As can be seen in FIG. 10, the portion of the capping sheet 322 is brought opposite to the openings 6 of pots by being connected in a continuous manner to the feed roll 321 of the capping sheet. In particular, the portion of the capping sheet 322 can cover the respective openings 6 of a number of n*m pots that are formed in a forming operation by the cavities of opening molds that are arranged in m rows as indicated above. The n*m pots can have, if necessary, their collars 8 connected to one another by residual portions of the portion of the sheet of materials 312.

Finally, the production line can also comprise, as is known, a device for metering contents 350 as well as a device for cutting out pots 340, illustrated in FIG. 10.

1. Pot with an undercut (1) that comprises a bottom wall (2) as well as a side wall (3) that is closed on itself and connected to the bottom wall (2), with the side wall and the bottom wall comprising an inside surface (4) that defines a pot's interior as well as an outside surface (5) that is opposite to the inside surface,
with the pot also comprising an opening (6) that provides access to the pot's interior, said opening (6) being able to be covered by a top closure (7) to insulate the pot's interior, with the opening extending along a horizontal plane (H) and defining a vertical direction (Z), perpendicular to the horizontal plane (H), passing through a barycenter of the opening and oriented from the bottom wall to the opening,
with the pot being wherein the outside surface (5) of the side wall (3) of the pot has a non-symmetrical undercut shape for rotation around the vertical direction (Z),
said outside surface (5) having at least one vertical demolding plane (P) such that an undercut value of the pot with respective side ends of the pot, with a maximum side spacing of the outside surface in relation to the vertical demolding plane (P), is less than a maximum undercut value of the pot (1) on the circumference of the outside surface (5) of the pot.

2. Pot according to claim 1, wherein the vertical demolding plane (P) is defined by the vertical direction (Z) and a demolding direction (D) of the horizontal plane (H), and is such that a side spacing E(t,z)=R(t,z)sin(θ(t,z)) of the outside surface (5) in relation to the demolding direction (D) is
a convex function for t varying from 0 to 1, with a maximum side spacing value of DM1(t1,z)=max_{t∈[0,1]}E(tz) at a position t1(z) of the first mold opening section, and a concave function for t varying from 1 to 2, with a maximum side spacing value of DM2(t2,z)=max_{t∈[1,2]}(−E(t,z)) at a position t2(z) of the second mold opening section, where
z is a distance to the bottom wall from a point of the outside surface of the side wall, in the vertical direction (Z),
t∈[0,2] is a circumferential position from a point of the outside surface (5) such that t=0 at an intersection between the outside surface (5) and the demolding direction (D), t=1 at an intersection between the outside surface and the direction that is opposite to the demolding direction (D), and t varies from 0 to 2 by passing through a complete circumference of the outside surface around the vertical direction (Z),
θ(t,z) is an angle that is oriented in the horizontal plane (H) in relation to the demolding direction (D) from a point of the outside surface to the position t and the height z, and
R(t,z) is a distance in the vertical direction (Z), in the horizontal plane (H), from a point of the outside surface (5) to the position t and the height z,
and the outside surface of the side wall has:
A height z1=argmax_{z}(DM1(t1(z),z)) with maximum spacing of the first undercut at the location of the first mold opening section,
A height z1′=argmin_{z>z1}(DM1(t1(z),z)) with minimum spacing of the first undercut at the location of the first mold opening section,
A height z2=argmax,(DM2(t2(z),z)) with maximum spacing of the second undercut at the location of the second mold opening section,
A height z2′=argmin_{z>z2}(DM2(t2(z),z)) with minimum spacing of the second undercut at the location of the second mold opening section.

3. Pot according to claim 2, wherein
An overhang of the first undercut at the location of the first mold opening section D1(t1)=R(t1(z1),z1)−R(t1(z1′),z1′) is smaller than a maximum overhang of the first undercut D1ₘₐₓ=maxₜ(R(t,z1))−minₜ(R(t,z1′)) on the circumference of the outside surface of the pot, and
An overhang of the second undercut at the location of the second mold opening section D2(t2)=R(t2(z1),z2)−R(t2(z2′),z2′) is smaller than a maximum overhang of the second undercut D2ₘₐₓ=maxₜ(R(t,z2))−minₜ(R(t,z2′)) on the circumference of the outside surface of the pot.

4. Pot according to claim 2, wherein the outside surface (5) of the side wall (3) of the pot is such that
A longitudinal distance from the first undercut on a first half of the pot D1_{long}(t)=F(c1(t),z1)−F(t,z1′) for t∈[0,t1(z1′)] has a local minimum at the location of the first mold opening section t=t1(z1′),
A longitudinal distance from the first undercut on a second half of the pot D1_{long}(t)=F(c2(t),z1)−F(t,z1′) for t∈[t1(z1′),1] has a local minimum at the location of the first mold opening section t=t1(z1′),
A longitudinal distance from the second undercut on a second half of the pot D2_{long}(t)=F(c3(t),z2)−F(t,z2′) for t∈[1,t2(z2′)] has a local minimum at the location of the second mold opening section t=t2(z2′),
A longitudinal distance from the second undercut on a first half of the pot D2_{long}(t)=F(c4(t),z2)−F(t,z2′) for t∈[t2(z2′),2] has a local minimum at the location of the second mold opening section t=t2(z2′),
where
F(t,z)=R(t,z)cos(θ(t,z)) is a longitudinal spacing of the outside surface (5) of said side wall in the demolding direction (D),
c1(t) is a longitudinal conversion of the position of the first undercut on a first half of the pot such that sin(θ(c1(t),z1)) R(c1(t),z1)=sin(θ(t,z1′)) R(t,z1′) for t∈[0,t1(z1′)],
c2(t) is a longitudinal conversion of the position of the first undercut on a second half of the pot such that sin(θ(c2(t),z1)) R(c2(t),z1)=sin(θ(t,z1′)) R(t,z1′) for t∈[t1(z1′),1],
c3(t) is a longitudinal conversion of the position of the second undercut on a second half of the pot such that sin(θ(c3(t),z2)) R(c4(t),z2)=sin(θ(t,z2′)) R(t,z2′) for t∈[1,t2(z2′)], and
c4(t) is a longitudinal conversion of the position of a second undercut on a first half of the pot such that sin(θ(c4(t),z2)) R(c3(t),z2)=sin(θ(t,z2′)) R(t,z2′) for t∈[t2(z2),2].

5. Pot according to claim 2, wherein
A lateral distance from the first undercut D1ₗₐₜ(t)=E(d(t),z1)−E(t,z1′) has a local minimum at the location of the first mold opening section t=t1(z1′), and
A lateral distance from the second undercut D2ₗₐₜ(t)=E(d(t),z2)−E(t,z2′) has a local minimum at the location of the second mold opening section t=t2(z2′),
where
d1(t) is a lateral conversion of the position of the first undercut such that d1(t)=argmaxₜ′(θ(t′,z1)=θ(t,z1′)), and
d2(t) is a lateral conversion of the position of the second undercut such that d2(t)=argmaxₜ′θ(t,z2′))).

6. Pot according to claim 1, wherein the distance from the first undercut at the location of the first mold opening section D1(t1) and the distance from the second undercut at the location of the second mold opening section D2(t2) are respectively smaller than one-fourth of the maximum spacing of the first undercut at the location of the first mold opening section DM1(t1,z1) and one-fourth of the maximum spacing of the second undercut at the location of the second mold opening section DM2(t2,z2), preferably respectively less than one-tenth of the maximum spacing of the first undercut at the location of the first mold opening section DM1(t1,z1) and one-fourth of the maximum spacing of the second undercut at the location of the second mold opening section DM2(t2,z2).

7. Pot according to claim 1, wherein the first mold opening section and the second mold opening section are essentially opposite to one another in relation to the longitudinal axis (Z).

8. Pot according to claim 1, wherein the first mold opening section and the second mold opening section are at right angles in relation to the demolding direction (D) in the vertical direction (Z), in such a way that θ(t1(z),z)=π/2 and θ(t2(z),z)=π/2 over the entire height z of the pot.

9. Pot according to claim 1, wherein the opening (6) is surrounded by a flat collar (8) that extends into the horizontal plane (H), suitable for making possible the attachment of a top closure (7) on the pot in such a way as to close the pot (1) in an airtight manner.

10. Pot according to claim 1, wherein the pot (1) is made of plastic material.

11. Pot according to claim 1, wherein the opening (6) of the pot is sealed by a top closure (7).

12. Opening mold (100) that is specially designed to be used in a forming machine (200) to shape at least one pot (1) according to claim 1, comprising a first sub-mold (110) and a second sub-mold (120), with said sub-molds being adapted to be moved in a demolding direction (D) between a closed position in which the first sub-mold and the second sub-mold are in mutual contact and an open position in which said sub-molds are separated from one another,
with said first sub-mold and second sub-mold forming at least one inside cavity (130) in the closed position of the mold, said at least one cavity being defined by an inside surface of the cavity (131) comprising an inside surface of the first sub-mold (111) and an inside surface of the second sub-mold (121), with the cavity being open at the location of an upper surface (101) of the opening mold, by an upper opening (140) that extends along a horizontal plane (H) comprising the demolding direction (D), the upper opening defining a vertical direction of the cavity (Z), perpendicular to the horizontal plane (H), passing through a barycenter of said upper opening and oriented from a cavity bottom toward the upper opening,
with the opening mold being wherein the inside surface of the cavity (131) in the closed position has a non-symmetrical undercut shape for rotation around the vertical direction (Z),
with said inside surface having a vertical demolding plane (P) comprising the vertical direction (Z) as well as the demolding direction (D) and being such that an undercut value of the mold at the respective side ends of the inside cavity of the mold, with maximum side spacing of the inside surface in relation to the vertical demolding plane (P), is less than a maximum undercut value of the mold on the circumference of the inside surface of the inside cavity.

13. Opening mold according to claim 12, wherein the vertical demolding plane (P) is such that a side spacing E(t,z)=R(t,z)sin(θ(t,z)) of the inside surface of the cavity (131) of the opening mold in the closed position in relation to the demolding direction (D) is a
convex function for t varying from 0 to 1, with a maximum value of side spacing DM1(t1,z)=max_{t∈[0,1]}E(t,z) at a position t1(z) of the first mold opening section corresponding to a location for contact between respective first opening surfaces of the first sub-mold and the second sub-mold, and a
concave function for t varying from 1 to 2, with a maximum value of side spacing DM2(t2,z)=max_{t∈[1,2]}(−E(t,z)) at a position t2(z) of the second mold opening section corresponding to a location for contact between the respective second opening surfaces of the first sub-mold and the second sub-mold, where
z is a distance to the cavity bottom from a point of the inside surface of the cavity, in the vertical direction (Z),
t∈[0,2] is a circumferential position from a point of the inside surface such that t=0 at an intersection between the inside surface and the demolding direction (D), t=1 at an intersection between the inside surface and the direction that is opposite to the demolding direction (D), and t varies from 0 to 2 by passing through a complete circumference of the inside surface around the vertical direction (Z),
θ(t,z) is an angle that is oriented in the horizontal plane (H) in relation to the demolding direction (D) from a point of the inside surface to the position t and the height z, and
R(t,z) is a distance in the vertical direction (Z), in the horizontal plane (H), from a point of the inside surface to the position t and the height z,
and the inside surface of the cavity has:
A height z1=argmax_{z}(DM1(t1(z),z)) of maximum spacing of the first undercut at the location of the first mold opening section,
A height z1′=argmin_{z>z1}(DM1(t1(z),z)) of minimum spacing of the first undercut at the location of the first mold opening section,
A height z2=argmax_{z}(DM2(t2(z),z)) of maximum spacing of the second undercut at the location of the second mold opening section,
A height z2′=argmin_{z>z2}(DM2(t2(z),z)) of minimum spacing of the second undercut at the location of the second mold opening section.

14. Opening mold according to claim 13, wherein
An overhang of the first undercut at the location of the first mold opening section D1(t1)=R(t1(z1),z1)−R(t1(z1′),z1′) is smaller than a maximum overhang of the first undercut D1ₘₐₓ=maxₜ(R(t,z1))−minₜ(R(t,z1′)) on the circumference of the inside surface of the cavity, and
An overhang of the second undercut at the location of the second mold opening section D2(t2)=R(t2(z1),z2)−R(t2(z2′),z2′) is smaller than a maximum overhang of the second undercut D2ₘₐₓ=maxₜ(R(t,z2))−minₜ(R(t,z2)) on the circumference of the inside surface of the cavity.

15. Opening mold according to claim 13, wherein the inside surface of the cavity (131) is such that
A longitudinal distance from the first undercut on a first cavity half D_{long}(t)=F(c1(t),z1)−F(t,z1′) for t∈[0,t1(z1′)] has a local minimum at the location of the first mold opening section t=t1(z1′),
A longitudinal distance from the first undercut on a second cavity half D1_{long}(t)=F(c2(t),z1)−F(t,z1′) for t∈[t1(z1′),1] has a local minimum at the location of the first mold opening section t=t1(z1′),
A longitudinal distance from the second undercut on a second cavity half D2_{long}(t)=F(c3(t),z2)−F(t,z2′) for t∈[1,t2(z2′)] has a local minimum at the location of the second mold opening section t=t2(z2′),
A longitudinal distance from the second undercut on a first cavity half D2_{long}(t)=F(c4(t),z2)−F(t,z2′) for t∈[t2(z′),2] has a local minimum at the location of the second mold opening section t=t2(z2′),
where
F(t,z)=R(t,z)cos(θ(t,z)) is a longitudinal spacing of the inside surface of the cavity in the demolding direction (D),
c1(t) is a longitudinal conversion of the position of the first undercut on a first cavity half such that sin(θ(c1(t),z1)) R(c1(t),z1)=sin(θ(t,z1′) R(t,z1′) for t∈[0,t1(z1′)],
c2(t) is a longitudinal conversion of the position of the first undercut on a second cavity half such that sin(θ(c2(t),z1)) R(c2(t),z1)=sin(θ(t,z1′) R(t,z1′) for t∈[t1(z′),1],
c3(t) is a longitudinal conversion of the position of the second undercut on a second cavity half such that sin(θ(c3(t),z2)) R(c4(t),z2)=sin(θ(t,z2′)) R(t,z2′) for t∈[1,t2(z2′)], and
c4(t) is a longitudinal conversion of the position of the second undercut on a first cavity half such that sin(θ(c4(t),z2)) R(c3(t),z2)=sin(θ(t,z2′)) R(t,z2′) f or t∈[t2(z2),2].

16. Opening mold according to claim 13, wherein
A lateral distance from the first undercut D1ₗₐₜ(t)=E(d(t),z1)−E(t,z1′) has a local minimum at the location of the first mold opening section t=t1(z1′), and
A lateral distance from the second undercut D2ₗₐₜ(t)=E(d(t),z2)−E(t,z2′) has a local minimum at the location of the second mold opening section t=t2(z2′),
where
d1(t) is a lateral conversion of the position of the first undercut such that d1(t)=argmaxₜ′(t′,z1)=θ(t,z1′), and
d2(t) is a lateral conversion of the position of the second undercut such that d2(t)=argmaxₜ′(t′,z2)=θ(t,z2′)).

17. Opening mold according to claim 12, wherein said first sub-mold (110) and second sub-mold (120) form, in the closed position of the mold, a number of inside cavities (130) that are aligned in a longitudinal direction (X).

18. Opening mold according to claim 12, wherein in the open position, the first sub-mold (110) and the second sub-mold (120) are separated from one another, in the demolding direction (D), by a distance from the opening O of between one and three times a sum between a maximum distance from the undercut of the side wall in the demolding direction (D) and a maximum distance from the undercut of the side wall in the direction that is opposite to the demolding direction (D).

19. Forming machine (200) that comprises at least one opening mold (100) according to claim 12.

20. Forming machine according to claim 19, comprising a number of opening molds (100) that are aligned for forming at least two rows of molds (210) that each extend in a longitudinal direction (X) that is perpendicular to the demolding direction (D) of said opening molds, each row of molds (210) comprising one or more opening molds that are juxtaposed in the longitudinal direction (X), with said rows of molds being arranged with a spatial period p in the demolding direction (D), in which said spatial period p is less than one and one-half times a maximum dimension of the inside cavity (131) of an opening mold (100) in the demolding direction (D).

21. Forming machine according to claim 19, also comprising at least one locking device (240) for separating opening molds that are put under pressure, with said locking device (240) for separating comprising a first cam (241) and a second cam (242), said first and second cams respectively coming into contact with the first sub-mold (110) and the second sub-mold (120) of an opening mold in the closed position in such a way as to prevent a relative movement of said sub-molds in the demolding direction (D), with said first and second cams (241, 242) coming into contact with said first and second sub-molds by a side that is opposite to the upper surface (101) of said opening mold (100) in the vertical direction (Z) in such a way as not to exceed the upper surface of said opening mold in the vertical direction (Z).

22. Line for producing pots by forming, comprising a forming machine (200) according to claim 19 as well as intake means of a sheet of material for forming (310) starting from at least one feed roll (311), with the intake means of said sheet of material for forming being suitable for bringing a portion of the sheet of material (312) into contact with the upper face (101) of the opening molds (100), with said portion of the sheet of material being connected in a continuous manner to the feed roll (311).

23. Line for producing pots by forming according to claim 22, wherein said portion of the sheet of material (312) in contact with the upper face (101) of the opening molds (100) covers at least at least [sic] two rows (210) of opening molds of the forming machine.

24. Line for producing pots by forming according to claim 22, also comprising intake means of a capping sheet (320) starting from at least one feed roll (321), with said intake means of a capping sheet being adapted to bring a portion of the capping sheet (322) opposite to the opening (6) of rows of pots (1) that are shaped by the pot-forming machine (200), said pots having, if necessary, their collars (8) connected to one another by the portion of the sheet of materials, said portion of the capping sheet being connected in a continuous manner to the feed roll, with the line also comprising a device for sealing pots (330) that is suitable for bringing into contact and sealing said portion of the capping sheet with the collars of the pots.

25. Method for manufacturing pots by forming, wherein:
A line (300) for manufacturing pots by forming is arranged according to claim 22,
Starting from the feed roll (311), a portion of the sheet of material (312) is brought into contact with the upper face (101) of a number of opening molds (100) that are aligned for forming at least two rows of molds (210) that each extend in a longitudinal direction (X) that is perpendicular to the demolding direction (D) of said opening molds, said portion of the sheet of material being connected in a continuous manner to the feed roll,
The pots (1) are formed in said opening molds.
